(19) United States
(12) Patent Application Publication
(10) Pub. No.: US 2025/0198094 A1
(43) Pub. Date: Jun. 19, 2025

(54) SYSTEM AND METHOD FOR INDICATING MOVEMENT PATH OF WORK MACHINE

(71) Applicant: Caterpillar Paving Products Inc., Brooklyn Park, MN (US)

(72) Inventor: Anthony Paul Steinhagen, Maple Grove, MN (US)

(73) Assignee: Caterpillar Paving Products Inc., Brooklyn Park, MN (US)

(21) Appl. No.: 18/544,545

(22) Filed: Dec. 19, 2023

(51) Int. Cl. E01C 19/00

(52) U.S. Cl. CPC E01C 19/006

(57) ABSTRACT

A system for indicating a movement path of a work includes an optical device, and a controller including at least one memory and at least one processor communicably coupled with the at least one memory. The at least one processor is communicably coupled with the optical device. The at least one processor is configured to determine at least one of a current movement path of the work machine and a proposed movement path of the work machine. The at least one processor is also configured to control the optical device to project a visual indicia on a ground surface around the work machine. The visual indicia represents at least one of the current movement path of the work machine and the proposed movement path of the work machine. The visual indicia provides a navigation aid to one or more personnel present around the work machine.

### TECHNICAL FIELD

The present disclosure relates to a system for indicating a movement path of a work machine and a method for indicating the movement path of the work machine.

### BACKGROUND

Work machines, such as pavers, operate at worksites to perform one or more work operations. It is desirable for machine manufacturers and contractors to increase efficiency and effectiveness of such work machines, as well as to ensure smooth operation of such work machines. A number of ground personnel may be present around the work machine to assist with the work operations. In some examples, the ground personnel may not be aware of a heading of the work machine at the worksite. Further, the machine operators may not be aware of a location of the ground personnel or may have limited visibility, thus, the machine operator may not be able to alert the ground personnel regarding the heading of the work machine. To ensure smooth operation at worksites, it may be desirable that the ground personnel is aware of the heading or movement direction of the work machine at all times, so that they are not standing in a path of the work machine.

U.S. Pat. No. 10,745,867 describes a paving machine comprising a material bunker for receiving a construction material, a chassis, an operator stand which is arranged behind the material bunker when seen in the construction direction, a paving screed which can be leveled for assembling the construction material onto a substrate, a material conveying unit which is configured to transport the construction material from the material bunker to the paving screed, and at least one optical projector which is configured to generate at least one projection in the visible spectrum on the substrate laterally and/or in front of the chassis of the paving machine when seen in the construction direction. The projection is visible to an operator of the paving machine from the operator stand when seen in the construction direction.

### SUMMARY OF THE DISCLOSURE

In an aspect of the present disclosure, a system for indicating a movement path of a work machine. The system includes an optical device. The system also includes a controller including at least one memory and at least one processor communicably coupled with the at least one memory. The at least one processor is communicably coupled with the optical device. The at least one processor is configured to determine at least one of a current movement path of the work machine and a proposed movement path of the work machine. The at least one processor is also configured to control the optical device to project a visual indicia on a ground surface around the work machine. The visual indicia represents at least one of the current movement path of the work machine and the proposed movement path of the work machine. The visual indicia provides a navigation aid to one or more personnel present around the work machine.

In another aspect of the present disclosure, a method for indicating a movement path of a work machine is provided. The method includes determining, by a controller associated with the work machine, at least one of a current movement path of the work machine and a proposed movement path of the work machine. The method also includes controlling, by the controller, an optical device associated with the work machine to project a visual indicia on a ground surface around the work machine. The method further includes indicating, based on projection of the visual indicia on the ground surface, at least one of the current movement path of the work machine and the proposed movement path of the work machine to one or more personnel present around the work machine.

Other features and aspects of this disclosure will be apparent from the following description and the accompanying drawings.

### BRIEF DESCRIPTION OF THE DRAWINGS

FIG. 1 is a perspective view of an exemplary work machine moving in a forward direction;

FIG. 2 is a block diagram of a system for indicating a movement path of the work machine of FIG. 1, according to an example of the present disclosure;

FIG. 3 is a perspective view of the work machine of FIG. 1 moving in a reverse direction; and

FIG. 4 is a flowchart of a method for indicating a movement path of the work machine of FIGS. 1 and 3, according to an example of the present disclosure.

### DETAILED DESCRIPTION

Wherever possible, the same reference numbers will be used throughout the drawings to refer to the same or like parts.

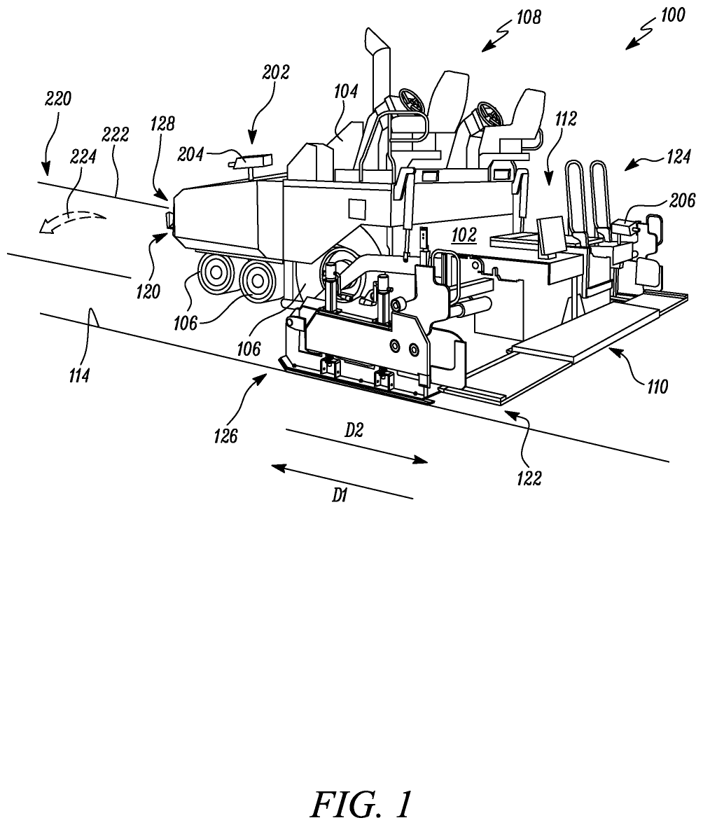

Referring to FIG. 1, an exemplary work machine 100 is illustrated. The work machine 100 includes a paving machine herein. The work machine 100 may be hereinafter interchangeably referred to as “paving machine 100”. Alternatively, the work machine 100 may include any other type of work machine, such as, an excavator, a grader, a dozer, a compactor, and the like. The work machine 100 may include an autonomous work machine, a semi-autonomous work machine, or a manually operated work machine. The work machine 100 includes a chassis 102. The chassis 102 supports various components of the work machine 100 thereon. The work machine 100 includes an enclosure 104 mounted on the chassis 102. The enclosure 104 encloses a power source (not shown) therein. The power source may be any power source, such as an internal combustion engine, a battery system, a fuel cell, and so on. The power source provides power to the work machine 100 for operational and mobility requirements.

The work machine 100 also includes a set of ground engaging members 106. The ground engaging members 106 are operably coupled to the chassis 102. In the illustrated example of FIG. 1, the ground engaging members 106 include wheels. In other embodiments, the ground engaging members 106 may include tracks or drums. The ground engaging members 106 support and provide maneuverability to the work machine 100 on a ground surface 114.

The work machine 100 also includes a machine operator station 108 mounted on the chassis 102. An operator seated in the machine operator station 108 may control various functions associated with the work machine 100 and, in some examples, functions associated with a screed assembly 110. The work machine 100 also includes a screed operator station 112. An operator present in the screed operator station 112 may control various functions associated with the screed assembly 110 and, in some examples, functions associated with the work machine 100.

The work machine 100 has a front end 120 and a rear end 122. The work machine 100 also has a first side 124 and a second side 126. Further, the work machine 100 may move in a forward direction D1 and a reverse direction D2. The work machine 100 also includes a hopper assembly 128 operably coupled to the chassis 102. The hopper assembly 128 is disposed proximate to the front end 120 of the work machine 100. The hopper assembly 128 holds a volume of paving material (not shown) on the work machine 100 received from an external source (not shown), such as, a truck or transfer vehicle. The hopper assembly 128 also transfers the paving material from one portion of the work machine 100 to another. As such, the hopper assembly 128 may include one or more components (not shown), such as one or more conveyors, augers, sensors, and so on, based on application requirements.

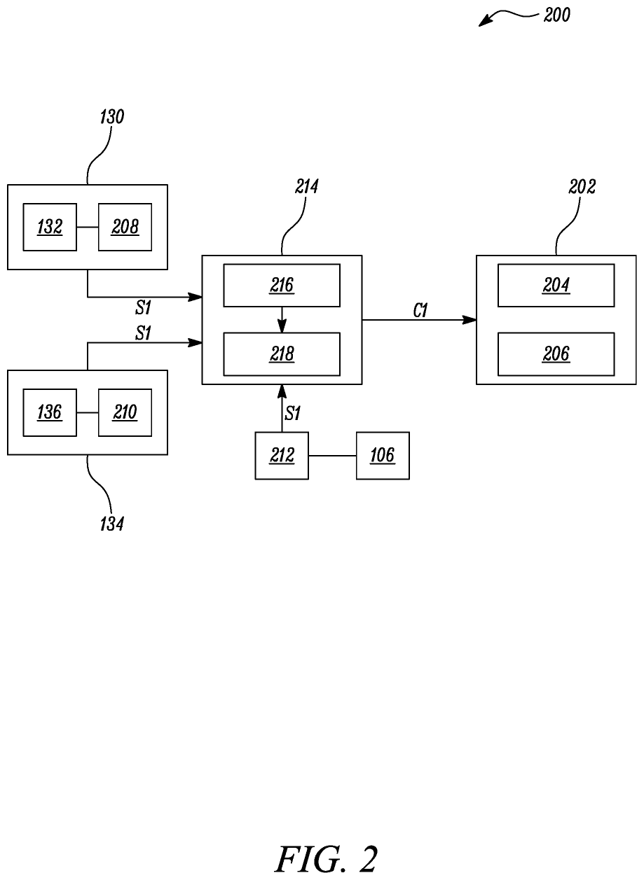

The work machine 100 further includes a steering system 130 (shown in FIG. 2). The steering system 130 may include a steering wheel 132 (shown in FIG. 2) that may be operated by the operator to steer the work machine 100. The work machine 100 further includes a propel system 134 (shown in FIG. 2). The propel system 134 may include a propel lever 136 (shown in FIG. 2) that may be operated by the operator to propel the work machine 100 in the forward direction D1 or the reverse direction D2. The work machine 100 also includes the screed assembly 110 mounted on the chassis 102. The screed assembly 110 is disposed proximate to the rear end 122 of the work machine 100. As such, the screed assembly 110 may pivot about a pivotal connection with the chassis 102 to float freely over a surface being paved.

Referring now to FIG. 2, the present disclosure relates to a system 200 for indicating a movement path of the work machine 100 of FIG. 1. The system 200 is associated with the paving machine 100 herein. Alternatively, the system 200 may be associated with any type of work machine, without any limitations. The system 200 includes an optical device 202. In the illustrated example of FIG. 2, the optical device 202 includes a first optical source 204 disposed proximal to the front end 120 (see FIG. 1) of the work machine 100. In some examples, the first optical source 204 includes a laser source. However, the first optical source 204 may include any other type of optical/light source known to persons having ordinary skill in the art. The optical device 202 also includes a second optical source 206 disposed proximal to the rear end 122 (see FIG. 1) of the work machine 100. Further, in some examples, the second optical source 206 includes a laser source. However, the second optical source 206 may include any other type of optical/light source known to persons having ordinary skill in the art.

The system 200 also includes a sensor 208, 210, 212 configured to generate a signal S1, S2, S3 indicative of a current movement path of the work machine 100. The sensor 208, 210, 212 may be associated with the steering system 130 of the work machine 100, the propel system 134 of the work machine 100, or the ground engaging member 106 of the work machine 100.

In one example, the sensor 208 may be a steering wheel angle sensor that may be coupled with the steering wheel 132 of the steering system 130 to indicate a current steering angle of the steering wheel 132. Alternatively, the sensor 208 may be coupled to a steering shaft of the steering system 130. In another example, the sensor 210 may include a propel lever sensor that that may be coupled with the propel lever 136 to indicate a position of the propel lever 136. In yet another example, the sensor 212 may include a wheel speed sensor associated with one or more of the ground engaging members 106 to generate a vehicle direction signal. Further, the sensors 208, 210, 212 may include any other type of sensor, that may be associated with any component of the work machine 100 to provide the signal S1, S2, S3 indicative of the current movement path of the work machine 100, without any limitations.

The system 200 further includes a controller 214 including one or more memories 216 and one or more processors 218 communicably coupled with the one or more memories 216. The one or more memories 216 may include any means of storing information, including a hard disk, an optical disk, a floppy disk, ROM (read only memory), RAM (random access memory), PROM (programmable ROM), EEPROM (electrically erasable PROM), and/or other computer-readable memory media. For example, the memories 216 may store data, such as, software applications, algorithms, instructions, and arithmetic operations.

The processors 218 may execute various types of digitally stored instructions, such as, software applications or algorithms, retrieved from the memories 216, or a firmware program which may enable the processors 218 to perform a wide variety of operations. It should be noted that the processors 218 may embody a single microprocessor or multiple microprocessors for receiving various input signals and generating output signals. Numerous commercially available microprocessors may perform the functions of the processors 218. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the memories 216.

The one or more processors 218 are communicably coupled with the optical device 202. Further, the sensor 208, 210, 212 is communicably coupled with the one or more processors 218. The one or more processors 218 determine the current movement path of the work machine 100 and/or a proposed movement path of the work machine 100. The term “current movement path” as used herein is indicative of a movement path or a heading direction of the work machine 100 in real time. Further, the term “proposed movement path” as used herein is indicative of a future, predicted, or planned movement path or a future, predicted, or planned heading direction of the work machine 100. In one example, the one or more processors 218 determine the current movement path of the work machine 100 based on the signal S1, S2, S3 generated by the sensor 208, 210, 212. It should be noted that the processors 218 may receive the signal S1, S2, S3 from the sensor 208, 210, 212 in real time to determine the current movement path of the work machine 100. It should be further noted that the processors 218 may receive the signal S1, S2, S3 from any one of the sensors 208, 210, 212 or from each of the sensors 208, 210, 212.

Further, in some examples, the operator of the work machine 100 may provide inputs to the processors 218 regarding the proposed movement path of the work machine 100 as per an intended work plan. In such examples, the processors 218 may determine the proposed movement path of the work machine 100 based on the inputs received from the operator. It should be noted that the system 200 or the work machine 100 may include additional sensors or devices that may provide inputs to the processors 218 regarding the proposed movement path of the work machine 100.

Further, in another example, the one or more memories 216 may store a work plan for the work machine 100. The work plan may include planned movement paths for the work machine 100 and/or planned work operations to be performed by the work machine 100. In such examples, the one or more processors 218 may retrieve the work plan from the one or more memories 216. Further, the one or more processors 218 may analyze the work plan to determine the current movement path of the work machine 100 and/or the proposed movement path of the work machine 100. Such a technique may be especially employed for autonomous or semi-autonomous work machines that move and operate according to predetermined work plans. It should be noted that the present disclosure is not limited by a technique using which the processors 218 determines the current movement path and/or the proposed movement path of the work machine 100.

Referring now to FIGS. 1 to 3, the one or more processors 218 also controls the optical device 202 to project a visual indicia 220 on the ground surface 114 around the work machine 100. Specifically, the one or more processors 218 may generate and transmit a control signal C1 to the optical device 202 to project the visual indicia 220 on the ground surface 114. The visual indicia 220 represents the current movement path of the work machine 100 and/or the proposed movement path of the work machine 100. The visual indicia 220 provides a navigation aid to one or more personnel present around the work machine 100. Specifically, the visual indicia 220 may provide navigation aid to ground personnel/crew that are present on the ground surface 114 on which the work machine 100 is operating.

Referring now to FIGS. 1 and 2, in some examples, when the work machine 100 is moving in the forward direction D1, the processors 218 may control the first optical source 204 to project the visual indicia 220 on the ground surface 114. Specifically, the first optical source 204 may project the visual indicia 220 on the ground surface 114 that is present in front of the work machine 100 and/or one or more sides 124, 126 of the work machine 100. Further, the first optical source 204 may be controlled by the processors 218 to project the visual indicia 220 in front of the work machine 100, on the first side 124 of the work machine 100, and/or on the second side 126 of the work machine 100, based on application requirements. In an example, the processors 218 may activate and control the first optical source 204 based on determining that the work machine 100 is moving in the forward direction D1. In some examples, it may also be contemplated that the visual indicia 220 is projected in front of the work machine 100 as well as behind the work machine 100, as per application requirements. In such examples, the first and second optical sources 204, 206 may be operated at the same time to display the visual indicia 220 in front of the work machine 100 as well as behind the work machine 100.

As shown in FIG. 1, the visual indicia 220 projected on the ground surface 114 includes a first pattern 222 and/or a second pattern 224. In the illustrated example of FIG. 1, the first pattern 222 indicates the current movement path of the work machine 100 and the second pattern 224 indicates the proposed movement path of the work machine 100. In the illustrated example of FIG. 1, the first pattern 222 indicative of the current movement path includes a pair of solid lines that indicate a straight movement path of the work machine 100. In the illustrated example of FIG. 1, the second pattern 224 includes a curved arrow, with dotted lines, that indicates the proposed movement path of the work machine 100 is along a curved path. It should be noted that the first pattern 222 and the second pattern 224 as depicted herein are exemplary in nature, and the first and second patterns 222, 224 may include any pattern, shape, design, size, and the like. In some examples, the visual indicia 220 may include an animated view of the current movement path and/or the proposed movement path of the work machine 100.

It should be further noted that, in some examples, the processors 218 (see FIG. 2) may be programmed such that the processors 218 control the first optical source 204 to project any one of the first pattern 222 and the second pattern 224 on the ground surface 114. For example, the operator may provide an input to the processors 218 to only project the first pattern 222 corresponding to the current movement path. In another example, the operator may provide an input to the processors 218 to only project the second pattern 224 corresponding to the proposed movement path.

Further, the first pattern 222 may include a first color scheme and the second pattern 224 may include a second color scheme. The first color scheme is different from the second color scheme. The different first and second color schemes may allow ground personnel to differentiate between the current movement path and the proposed movement path of the work machine 100. In one example, the first color scheme may include a blue color scheme and the second color scheme may include a red color scheme, without any limitations.

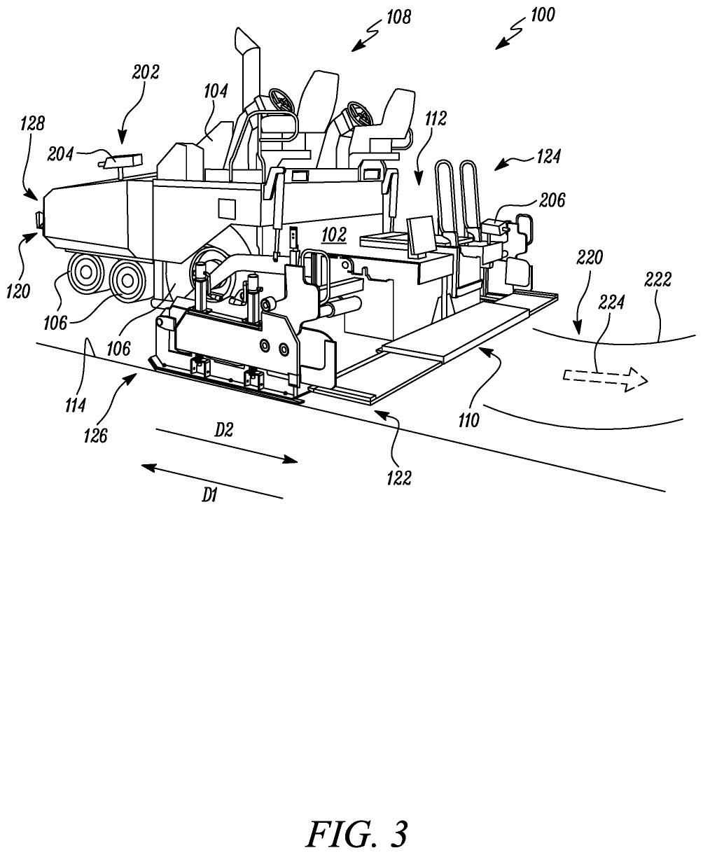

Referring now to FIGS. 2 and 3, in some examples, when the work machine 100 is moving in the reverse direction D2, the processors 218 may control the second optical source 206 to project the visual indicia 220 on the ground surface 114. Specifically, the second optical source 206 may project the visual indicia 220 on the ground surface 114 that is present behind the work machine 100 and/or one or more sides 124, 126 of the work machine 100. Further, the second optical source 206 may be controlled by the processors 218 to project the visual indicia 220 behind the work machine 100, on the first side 124 of the work machine 100, and/or on the second side 126 of the work machine 100, based on application requirements. In an example, the processors 218 may activate and control the second optical source 206 based on determining that the work machine 100 is moving in the reverse direction D2. In some examples, it may also be contemplated that the visual indicia 220 is projected in front of the work machine 100 as well as behind the work machine 100, as per application requirements. In such examples, the first and second optical sources 204, 206 may be operated at the same time to display the visual indicia 220 in front of the work machine 100 as well as behind the work machine 100.

As illustrated in FIG. 3, the first pattern 222 indicative of the current movement path includes a pair of curved solid lines that indicate a curved movement path of the work machine 100. Further, the second pattern 224 includes a straight arrow, with dotted lines, that indicates the proposed movement path of the work machine 100 is along a straight path.

It should be further noted that, in some examples, the processors 218 (see FIG. 2) may be programmed such that the processors 218 control the second optical source 206 to project any one of the first pattern 222 and the second pattern 224 on the ground surface 114. For example, the operator may provide an input to the processors 218 to only project the first pattern 222 corresponding to the current movement path. In another example, the operator may provide an input to the processors 218 to only project the second pattern 224 corresponding to the proposed movement path.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the system 200 for indicating the movement path of the work machine 100. The system 200 provides a cost-efficient approach of providing visual, navigation aid to ground personnel present around the work machine 100 to alert them regarding the current and/or proposed movement paths of the work machine 100. The visual indicia 220 may provide a real-time view of the current movement path of the work machine 100 to alert the ground personnel. The ground personnel may accordingly move as required so that they are distant from the current and/or proposed movement paths of the work machine 100.

The system 200 may be deployed on existing work machines with minimum modifications. Further, the visual indica 220 may have different patterns, such as the first and second patterns 222, 224, or different color schemes that may allow ground personnel to differentiate between the current and proposed movement paths, thereby improving awareness at the worksite. The system 200 may increase efficiency and productivity at the worksite, and may ensure smooth operation while minimizing downtime.

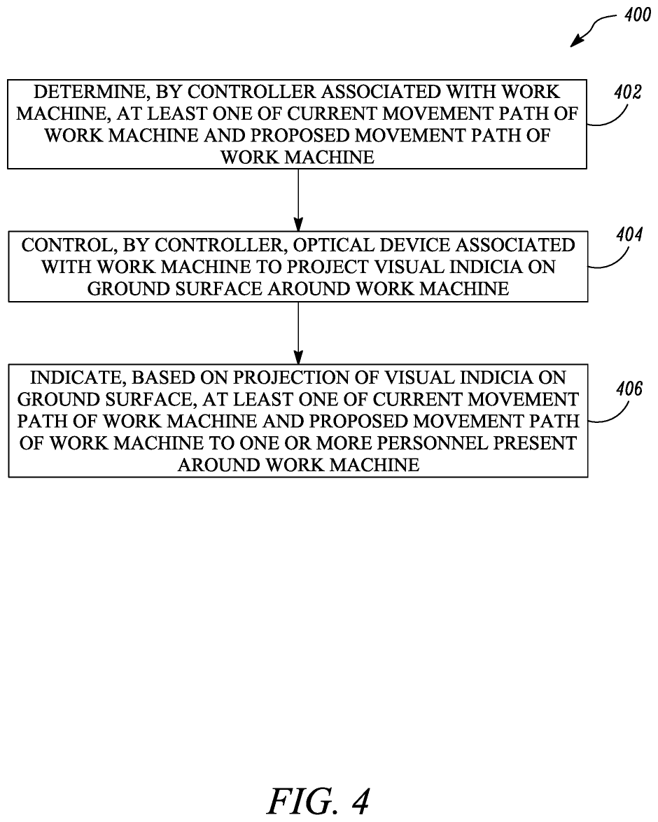

FIG. 4 is a flowchart for a method 400 for indicating the movement path of the work machine 100. Referring to FIGS. 1 to 4, at step 402, the controller 214 associated with the work machine 100 determines the current movement path of the work machine 100 and/or the proposed movement path of the work machine 100.

At step 404, the controller 214 controls the optical device 202 associated with the work machine 100 to project the visual indicia 220 on the ground surface 114 around the work machine 100. At step 406, the current movement path of the work machine 100 and/or the proposed movement path of the work machine 100 is indicated to the one or more personnel present around the work machine 100 based on projection of the visual indicia 220 on the ground surface 114.

The method 400 also includes a step (not shown) at which the sensor 208, 210, 212 associated with the work machine 100 generates the signal S1, S2, S3 indicative of the current movement path of the work machine 100. The method 400 also includes a step (not shown) at which the controller 214 receives the signal S1, S2, S3 from the sensor 208, 210, 212 to determine the current movement path of the work machine 100. The sensor 208, 210, 212 is communicably coupled with the controller 214. The sensor 208, 210, 212 is associated with the steering system 130 of the work machine 100, the propel system 134 of the work machine 100, and/or the ground engaging member 106 of the work machine 100.

The method 400 also includes a step (not shown) at which the controller 214 retrieves the work plan for the work machine 100. The method 400 also includes a step (not shown) at which the controller 214 analyzes the work plan to determine the current movement path of the work machine 100 and/or the proposed movement path of the work machine 100.

The method 400 also includes a step (not shown) at which the first optical source 204 of the optical device 202 projects the visual indicia 220 on the ground surface 114 that is present in front of the work machine 100 and/or one or more sides 124, 126 of the work machine 100. The first optical source 204 is disposed proximal to the front end 120 of the work machine 100.

The method 400 also includes a step (not shown) at which the second optical source 206 of the optical device 202 projects the visual indicia 220 on the ground surface 114 that is present behind the work machine 100 and/or one or more sides 124, 126 of the work machine 100. The second optical source 206 is disposed proximal to the rear end 122 of the work machine 100.

The visual indicia 220 projected on the ground surface 114 includes the first pattern 222 and/or the second pattern 224. The first pattern 222 indicates the current movement path of the work machine 100 and the second pattern 224 indicates the proposed movement path of the work machine 100. Further, the method 400 also includes a step (not shown) at which the optical device 202 projects the first pattern 222 and/or the second pattern 224 on the ground surface 114.

It may be desirable to perform one or more of the steps shown in FIG. 4 in an order different from that depicted. Furthermore, various steps could be performed together.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

1. A system for indicating a movement path of a work machine, the system comprising:
an optical device; and
a controller including at least one memory and at least one processor communicably coupled with the at least one memory, wherein the at least one processor is communicably coupled with the optical device, and wherein the at least one processor is configured to:
determine at least one of a current movement path of the work machine and a proposed movement path of the work machine; and
control the optical device to project a visual indicia on a ground surface around the work machine, wherein the visual indicia represents at least one of the current movement path of the work machine and the proposed movement path of the work machine, and wherein the visual indicia provides a navigation aid to one or more personnel present around the work machine.

2. The system of claim 1, further comprising a sensor configured to generate a signal indicative of the current movement path of the work machine, wherein the sensor is communicably coupled with the at least one processor, and wherein the at least one processor is configured to determine the current movement path of the work machine based on the signal generated by the sensor.

3. The system of claim 2, wherein the sensor is associated with at least one of a steering system of the work machine, a propel system of the work machine, and a ground engaging member of the work machine.

4. The system of claim 1, wherein the at least one memory is adapted to store a work plan for the work machine, and wherein the at least one processor is configured to:
retrieve the work plan from the at least one memory; and
analyze the work plan to determine at least one of the current movement path of the work machine and the proposed movement path of the work machine.

5. The system of claim 1, wherein the optical device includes a first optical source disposed proximal to a front end of the work machine.

6. The system of claim 5, wherein the first optical source is configured to project the visual indicia on the ground surface that is present in front of the work machine and/or at least one side of the work machine.

7. The system of claim 5, wherein the first optical source includes a laser source.

8. The system of claim 1, wherein the optical device includes a second optical source disposed proximal to a rear end of the work machine.

9. The system of claim 8, wherein the second optical source is configured to project the visual indicia on the ground surface that is present behind the work machine and/or at least one side of the work machine.

10. The system of claim 8, wherein the second optical source includes a laser source.

11. The system of claim 1, wherein the visual indicia projected on the ground surface includes at least one of a first pattern and a second pattern, and wherein the first pattern indicates the current movement path of the work machine and the second pattern indicates the proposed movement path of the work machine.

12. The system of claim 11, wherein the first pattern includes a first color scheme and the second pattern includes a second color scheme, and wherein the first color scheme is different from the second color scheme.

13. The system of claim 1, wherein the system is associated with a paving machine.

14. A method for indicating a movement path of a work machine, the method comprising:
determining, by a controller associated with the work machine, at least one of a current movement path of the work machine and a proposed movement path of the work machine;
controlling, by the controller, an optical device associated with the work machine to project a visual indicia on a ground surface around the work machine; and
indicating, based on projection of the visual indicia on the ground surface, at least one of the current movement path of the work machine and the proposed movement path of the work machine to one or more personnel present around the work machine.

15. The method of claim 14, further comprising:
generating, by a sensor associated with the work machine, a signal indicative of the current movement path of the work machine; and
receiving, by the controller, the signal from the sensor to determine the current movement path of the work machine, wherein the sensor is communicably coupled with the controller.

16. The method of claim 15, wherein the sensor is associated with at least one of a steering system of the work machine, a propel system of the work machine, and a ground engaging member of the work machine.

17. The method of claim 14, further comprising:
retrieving, by the controller, a work plan for the work machine; and
analyzing, by the controller, the work plan to determine at least one of the current movement path of the work machine and the proposed movement path of the work machine.

18. The method of claim 14, further comprising projecting, by a first optical source of the optical device, the visual indicia on the ground surface that is present in front of the work machine and/or at least one side of the work machine, wherein the first optical source is disposed proximal to a front end of the work machine.

19. The method of claim 14, further comprising projecting, by a second optical source of the optical device, the visual indicia on the ground surface that is present behind the work machine and/or at least one side of the work machine, wherein the second optical source is disposed proximal to a rear end of the work machine.

20. The method of claim 14, wherein the visual indicia projected on the ground surface includes at least one of a first pattern and a second pattern, and wherein the first pattern indicates the current movement path of the work machine and the second pattern indicates the proposed movement path of the work machine, the method further comprising projecting, by the optical device, at least one of the first pattern and the second pattern on the ground surface.
